(19) United States
(12) Patent Application Publication
(10) Pub. No.: US 2008/0283731 A1
(43) Pub. Date: Nov. 20, 2008

(54) Position Detection of an Electromagnetic Beam Projection

(75) Inventor: Gerardus Petrus Karman, S-Gravenhage (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/095,021

(22) PCT Filed: Nov. 21, 2006
(86) PCT No.: PCT/IB2006/054357

§ 371 Date: May 27, 2008

(30) Foreign Application Priority Data
Nov. 30, 2005 (EP) 05111519.4

(51) Int. Cl. G01J 1/42

(52) U.S. Cl. 250/208.6

(57) ABSTRACT

The invention relates to the detection of the position of a projection of an electromagnetic beam on a surface such as a laser pointer projection on a display screen. It is suggested to measure intensities of the electromagnetic radiation from the beam projection at three or more different positions at the borders of the surface and to process the measured intensities for determining the centre position of the electromagnetic beam projection on the surface. The intensities may be measured applying only a few low cost receivers. Thus, no optical add-ons or expensive position detection means with a plurality of photodiodes are required

The invention relates to the detection of the position of a projection of an electromagnetic beam on a surface, particularly the detection of the position of a cursor control projection on a display screen such as a computer or consumer electronics display screen.

A cursor on a display screen, which may display a graphical user interface (GUI), for example, can be controlled by a laser pointer. The laser pointer generates a laser beam which may be directed to the display screen in order to generate a laser spot as projection of the laser beam on the surface of the display screen. The laser spot corresponds to a cursor control which serves to determine the position and movements of the cursor in the displayed GUI. The position of the laser spot may be determined by photodiodes located at the edges of the display. However, this requires that radiation of the laser spot is directed to the photodiodes. Typically, this is accomplished by an add-on optical system to the display screen which usually consists of a transparent front plate mounted before the display screen and comprising micro indentations on its surface which steer the laser radiation towards the photodiodes located at the edges of the display screen. Such a transparent front plate adds significant costs and, furthermore, degrades the so-called front of screen performance of the underlying display screen.

US-Patent no. US 2005/0103924 A1 discloses a continuous aimpoint tracking system with a position detection device (PDD) and a laser pointing device (LPD). The LPD projects an infrared crosshair which extends over an entire display and onto the PDD. Evenly spaced photodiodes are positioned at the edges of the PDD in order to form a frame so as to surround the display. The photodiodes continuously detect the infrared crosshair. Thus, their signals allow extracting the coordinates of the centre position of the crosshair on the display. Though no add-on optical system is required, this solution is also costly since it requires a large number of photodiodes or four strip shaped position detection devices.

It is an object of the present invention to provide a device and a method for detecting the position of a projection of an electromagnetic beam on a surface such as a display screen which avoid the disadvantages defined above.

In order to achieve the object defined above, the invention provides a device for detecting a position of a projection of an electromagnetic beam on a surface, wherein the device comprises the following characteristic features:

at least three receivers for receiving electromagnetic radiation from the projection of the electromagnetic beam, wherein the receivers are located at different positions at the border of the surface,
intensity determination means being adapted to determine the intensities of the electromagnetic radiations received by the receivers, and
position detection means being adapted to determine the centre position x_{c} of the projection of the electromagnetic beam on the surface by processing the determined intensities.

In order to achieve the object defined above, the invention further provides a method for detecting a position of a projection of an electromagnetic beam on a surface, wherein the method comprises the following characteristic features:
electromagnetic radiation from the projection of the electromagnetic beam is received by at least three receivers being located at different positions at the border of the surface,
the intensities of the electromagnetic radiations received by the receivers are determined by intensity determination means, and
the centre position x_{c} of the projection of the electromagnetic beam on the surface is determined by position detection means by processing the determined intensities.

The characteristic features according to the invention provide the advantage that they can be implemented at lower costs than optical add-on systems, a large number of photodiodes or expensive position detection devices. In other words, the invention is a low cost implementation which does not require expensive and performance degrading elements. It may be implemented using standard components such as a few photodiodes in case of laser beam detection or antennas in case of radio wave beam detection. This simplifies systems based on the invention, improves their robustness and finally reduces their costs.

It should be noted that the term “electromagnetic beam” as used herein comprises any beam of electromagnetic radiation in a wide frequency range. For example, the electromagnetic beam may be a laser beam generated by a laser pointer or an infrared beam or a radio wave beam such as it is used by existing infrared or radio frequency (RF) based remote control (RC) devices.

The term “beam” used herein should be understood as a beam of which the shape (intensity of the electromagnetic radiation is a function of lateral distances from the optical axis) is known so that the beam's centre may be determined or at least estimated by means of a few intensity measurements at different positions at the border of the surface. Thus, beam means an electromagnetic beam with width such that also edge areas of the surface are at least slightly illuminated by the beam. Typically, electromagnetic beams being produced by laser pointing devices or the above mentioned RC devices may be used for the purposes of the invention.

The term “projection of an electromagnetic beam” means a spot of a beam which appears on a surface on which the beam is directed. This spot has a centre point with an intensity peak of the electromagnetic radiation. The centre point is surrounded by a neighbourhood of lower intensity electromagnetic radiation which may be analyzed by the invention for the determination of the position of the centre point. Typically, the distribution of intensity over the spot and the area illuminated by the beam is also referred herein under the term “intensity profile”. The intensity profile in the plane of the surface depends on the beams cross sectional profile, which may be circular, and the angle of inclination of the beam on the surface. If the angle of inclination is nearly 0°, the intensity profile in the plane of the surface is nearly circular symmetrical in case of a circular cross sectional beam's profile. Furthermore, the intensity profile depends on the intensity decrease off axis, i.e. the intensity decrease with increasing distance from the beam's optical axis. A laser beam typically has an intensity profile with a Gaussian shape which means that the intensity decreases in a Gaussian fashion with increasing distance form the beams optical axis. Beams generated by RC devices often do not have a Gaussian shape like intensity profile. However, for the purpose of the invention such intensity profiles may be approximated by a Gaussian to first order.

The term “centre point x_{c}” is to be understood in both one-dimensional and two-dimensional geometries, depending on the context. Thus, “centre point x_{c}” can denote either an x-coordinate or both an x- and y-coordinate.

The term “receivers for receiving electromagnetic radiation” comprises any receiving devices such as photo detectors or photodiodes sensitive to electromagnetic radiation to be detected, or RF sensitive detectors in case of a RF RC used as beam generating device.

The term “intensity determination means” comprises any means which are able to determine the intensity of electromagnetic radiation from signals or data received from the receivers. One or more receivers and the intensity determination means may be implemented as one unit, for example a photo detector as a receiver containing a circuitry which is adapted to convert an electric current or voltage generated by received electromagnetic radiation into an intensity output signal. Alternatively, the intensity determination means may be a separate unit which receives signals from the receivers such as an electric current or voltage corresponding to a received electromagnetic radiation and processes the received signals in that it converts the signals into the respective intensity. Preferably, the intensity determination means internally process signals or data in a digital manner and comprises some computing power for performing algorithms implemented in order to perform the conversion of the received signals or data into intensity data.

The term “position detection means” comprises any means able to determine the centre position x_{c} of the projection of the electromagnetic beam on the surface by processing the determined intensities. Particularly, the position detection means comprise an algorithm for calculating the centre position from the determined intensities. This algorithm preferably contains an implementation of a function of the intensity depending on the lateral distance from the optical axis of the electromagnetic beam. This function corresponds to the above explained intensity profile of the beam and allows to calculate the distance of a position from the centre point (corresponding to the optical axis) of the beam at which a certain intensity was determined. Furthermore, the algorithm may be adapted to determine the centre point position from at least three measured distances of known positions from the centre point which were determined by processing determined intensities. The at least three known positions are the positions of the at least three receivers for the electromagnetic radiation. In view of these data, the centre point may be determined by a geometrical calculation as will be explained in detail below. It should be noted that the mentioned algorithm may be implemented in soft- or hardware.

The basic idea of the invention is detecting a position of an electromagnetic beam projection on a surface by determining several distances of the centre point of the projection from known positions on or near the surface with intensity measurements of the electromagnetic radiation from the projection, and to determine the position of the centre point by means of the determined distances.

In order to determine the centre position of the projection of the electromagnetic beam on the surface with a high accuracy, it may be advantageous to provide four or more receivers for receiving electromagnetic radiation from the projection of the electromagnetic beam.

The position detection means may be adapted to calculate the centre position x_{c} of the projection of the beam on the surface from the determined intensities based on a predefined beam intensity profile. The intensity profile should match with the real intensity profile of the beam or at least be an approximation of the real intensity profile in order to achieve accurate position detection.

For example, the position detection means may implement a curve fitting algorithm for calculating the centre position x_{c} of the projection of the beam on the surface from the determined intensities based on a predefined beam intensity profile.

Also, a lookup table with a plurality of pre-measured values and corresponding positions together with interpolation means may be provided, and the position detection means may be adapted to load values corresponding to the determined intensities from the lookup table for calculating the centre position x_{c} of the projection of the beam on the surface.

Typically, the predefined beam intensity profile is a circular symmetric profile. Such a profile has the advantage that the position can be detected more easily than with another profile such as an angular profile.

In order to allow determining an angle of inclination of the beam on the surface, the position detection means may be adapted to determine a beam intensity profile for the determined intensities and calculate the angle of inclination in one or two dimensions from the determined beam intensity profile and its deviation from the predefined beam intensity profile. For example, if the predefined intensity profile is a circular symmetric profile, a determined elliptical profile indicates a certain angle of inclination. This inclination angle may be derived from the deviation of the detected intensity profile from the predefined intensity profile, for example by matching the determined intensity profile with stored profiles and their corresponding angles of inclination.

Preferably, the predefined beam intensity profile is a Gaussian profile. A Gaussian profile has the advantage that it matches typical beam intensity profiles such that of laser beams. However, also different intensity profiles may be processed since most profiles may be approximated with the Gaussian profile.

According to a preferred embodiment of the invention, the predefined beam intensity profile is a low intensity Gaussian profile with an additional small-width high intensity spot in the middle of the profile. This has the advantage that a user can easily recognize the beam on the surface if the beam is a laser or light beam in the visible range.

According to a further embodiment of the invention, the receivers may be sensitive to different wavelengths of received electromagnetic radiation and the intensity determination means may be adapted to assign the determined intensities of the electromagnetic radiations with different wavelengths to positions of different electromagnetic beams. This is particularly useful in combination with multi-view display screens which show different images under different viewing angles such that different users can use the same display screen each using their own remote control device to interact with the multi-view display.

In order to allow different users to use the same display screen, the receivers may also be adapted to receive electromagnetic radiation from the projection of an intensity modulated electromagnetic beam and the intensity determination means may be adapted to assign the determined intensities of the electromagnetic radiations with different intensity modulations to positions of different electromagnetic beams. In other words, each user using an electromagnetic beam to control a cursor on a display screen may have his/her own specifically intensity modulated beam.

According to an embodiment of the invention, the electromagnetic beam may be a beam of visible light and the receivers are sensitive to visible light. This has the advantage that a user can see the projection of the electromagnetic beam on the surface.

According to a preferred embodiment of the invention, the electromagnetic beam is a laser beam and the receivers are photodiodes. A laser beam is commonly used for laser pointing devices and, thus, a common and inexpensive device.

In order to avoid large circular floodlights generated by a laser beam on the surface as if someone is shining a flashlight on the screen, the laser beam should have such a low intensity as to render it nearly invisible to the naked human eye. Alternatively or additionally, the laser beam may have a nonvisible, particularly infrared wavelength.

Alternatively, the laser beam may use a nonvisible, preferably an infrared wavelength in order to be invisible to the naked human eye.

However, according to a further embodiment of the invention, the electromagnetic beam may also be a radio wave beam and the receivers are antennas. A radio wave beam has the advantage that it is not as easily disturbed by objects passing the beam as a laser beam since radio waves penetrate a lot of objects. In addition, RF based remote control devices are widely used in practice; therefore, the present invention is fully compatible with the use of these type of remote controls.

The invention is preferably applied to display screens and, therefore, the surface may be a display screen and the receivers may be located at edges of the display screen. for example, the display screen may be a computer or consumer electronics display screen displaying a GUI for controlling a computer or a consumer electronics device. The receivers may be integrated in the frame of the display screen such that they are not visible for users.

Typically, the display screen has a rectangular form and each of the receivers is located in a different corner of the display screen. This has the advantage that accurate position detection is possible. However, it should be noted that the display screen may have another form such as a circular or elliptical form without departing from the scope of the invention.

The invention may be advantageously applied to a multi-view display screen. Thus, the display screen may be a multi-view display screen, and the intensity determination means may be adapted to determine the intensities of the electromagnetic radiations received by the receivers from different electromagnetic beams and the position detection means may be adapted to determine the centre position x_{c} of the projection of each of the different electromagnetic beams on the multi-view display screen by processing the determined intensities.

According to a further aspect, the invention relates to a display screen unit such as a computer monitor or a television screen comprising a display screen and device according to any of the before discussed embodiments of the invention for detecting the position of a projection of an electromagnetic beam on the display screen.

The display screen unit may further comprise a computer for controlling the position of a cursor displayed on the display screen of the display screen unit based on the detected position of the projection of the electromagnetic beam on the display screen. Thus, an autonomous unit is created which does not require any external computing device in order to control the cursor. For example, such a unit may be used for controlling several computing or consumer electronics devices via an interface over which the unit receives video signals form the external devices.

These and other aspects of the invention will be apparent from and elucidated with reference to the embodiment(s) described hereinafter.

The invention will be described in more detail hereinafter with reference to exemplary embodiments. However, the invention is not limited to these exemplary embodiments.

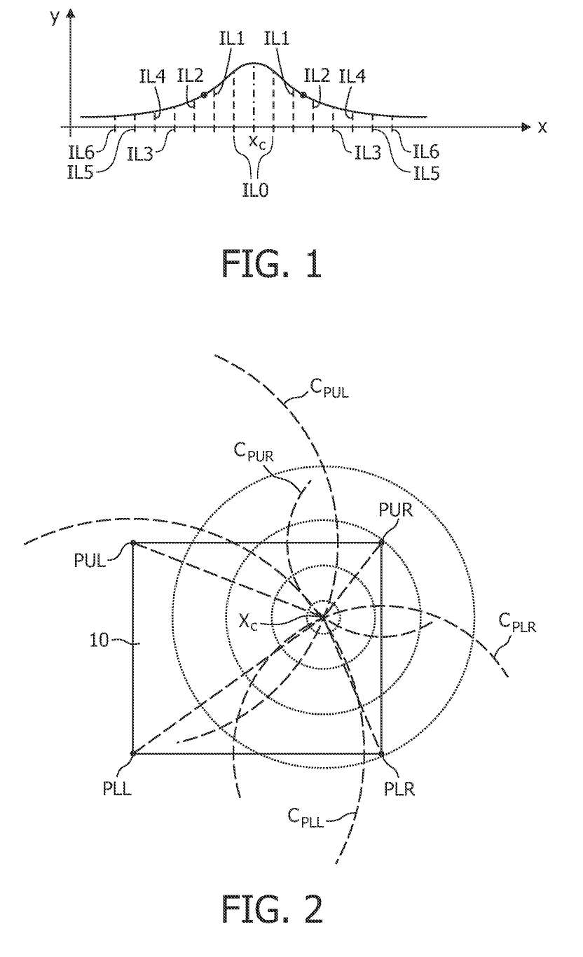

FIG. 1 a diagram of the intensity of a projection of a typical laser beam generated by a laser pointer on a plane surface such as a display as a function y of the lateral distance x;

FIG. 2 a schematic view of an embodiment of the invention with four photodiodes located at the corners of a display screen and the equi-intensity lines of the projection of a laser beam from a laser pointer on the display screen as well as lines of the intensity measured by the single photodiodes; and

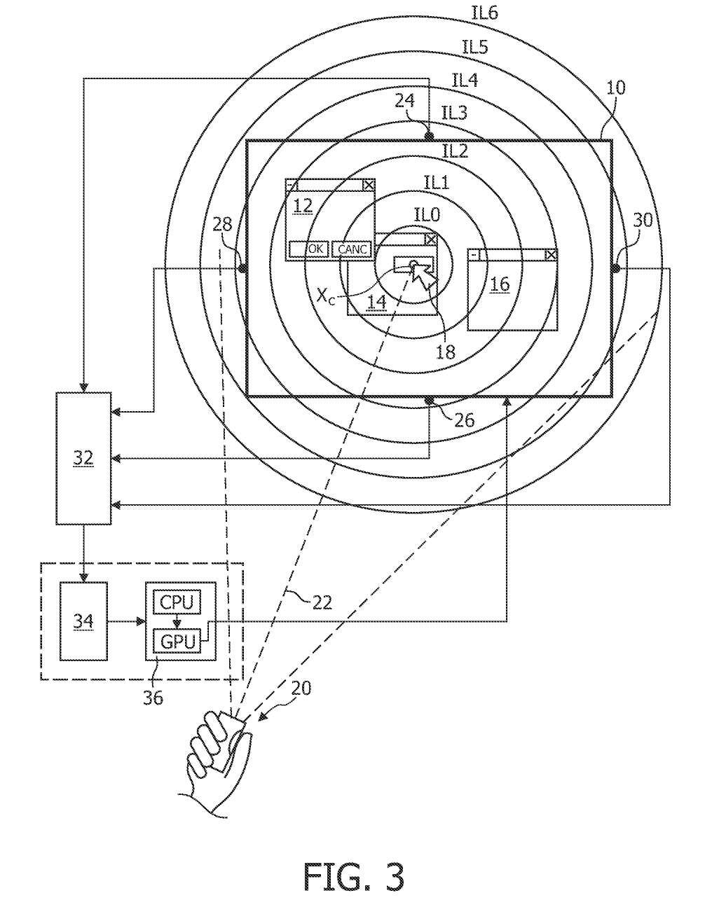

FIG. 3 a schematic view of a further embodiment of the invention comprising four photodiodes located at the edges of a display screen, means for processing the intensities measured by the photodiodes and means for controlling the position of a cursor of a GUI displayed on the screen.

In the following, functional similar or identical elements may have the same reference numerals.

FIG. 1 shows the course of the intensity of the electromagnetic radiation of a typical electromagnetic beam projection on a surface such as a plane display or screen, respectively. The course of the intensity is a function y of the lateral distance x from a centre point x_{c}. Typically, the beam emitted by a laser pointer has a nearly Gaussian shape. This results in a intensity function with a nearly Gaussian profile as shown in FIG. 1. However, also electromagnetic beams with another shape may be applied for the purpose of the invention as long as the course of the intensity as a function of the lateral distance x is known and can be fitted to a few intensity measurements.

The centre point x_{c} is the centre of the projection of the laser beam with the highest intensity. The course of intensity is circular symmetrical around the centre point x_{c} if the angle of incidence of the electromagnetic beam on the plane display is about 0°. The more the angle of incident deviates from 0°, the more the course of intensity is unsymmetrical or elliptical symmetrical. However, if the distance of the source of the electromagnetic beam is much larger than the dimensions of the surface on which the beam is projected, an approximation of the course of intensity as shown in FIG. 1 may be sufficient for the purpose of the invention.

In FIG. 1, black dots on the intensity course represent measured intensities at three different locations. This will be explained below in more detail when discussing FIG. 2. FIG. 1 further shows equi-intensity lines IL0, IL1, IL2, IL3, IL4, IL5, and IL6. The intensity on these lines is nearly equal. The lines correspond to circles around the centre point x_{c} as it is shown in FIG. 3. Since the intensity of the electromagnetic radiation around the centre position x_{c} decreases with the distance x from the centre point x_{c} according to the shown and known function y, it is possible to derive the position of the electromagnetic beam projection on the surface from measurements of the intensity of the electromagnetic radiation at different locations round the centre point x_{c}. This will be explained in the following with regard to FIG. 2.

FIG. 2 shows a rectangular plane surface 10 such as a display or a screen, respectively. In the corners of the rectangular surface 10, receivers PUL, PUR, PLL, and PLR for electromagnetic radiation from an electromagnetic beam projection with a centre point x_{c} are located. If the electromagnetic radiation to be detected is within the range of light waves, the receivers are photodiodes. The receivers may also be radio frequency antennas if the electromagnetic radiation to be detected is within the range of radio waves. It should be noted that an electromagnetic beam for controlling a cursor on the display may be a laser light beam or a radio wave beam (with a focused beam similar to a laser beam).

Lines of equi-intensity of the electromagnetic radiation of the electromagnet beam projection are circles around the centre point x_{c}. The distance of the centre point x_{c} from each receiver PUL, PUR, PLL, and PLR is represented by a broken straight line from a receiver to the centre point x_{c}. Since the centre point x_{c} lies out of the middle point of the surface of the display 10, each of the receivers PUL, PUR, PLL, and PLR has a different distance from the centre point x_{c}. The receiver PUR in the upper right corner of the display 10 is closest to the centre point x_{c} while the receiver PLL in the lower left corner of the display 10 has the largest distance to the centre point x_{c}. Thus, each of the receivers PUL, PUR, PLL, and PLR measures a different intensity of the electromagnetic radiation of the electromagnetic beam projection. The measured intensities in the situation shown in FIG. 2 behave like I_{PLL}<I_{PUL}<I_{PLR}<I_{PUR} wherein I_{XXX} means measured intensity at a receiver location XXX. If the intensity at the centre point x_{c} and the course of the intensity as a function of the lateral distance x from the centre point x_{c} are known (e.g., the course shown in FIG. 1), the measured intensity at a certain receiver location may be converted into a corresponding distance of the receiver position from the centre point x_{c}. The position of the centre point x_{c} lies on the intersection of the circles C_{PUL}, C_{PUR}, C_{PLL}, and C_{PLR} which are partly shown in FIG. 2 by circle segments with broken lines. The radius of each circle corresponds to the distance derived from the intensity measured by a respective receiver. Thus, by converting each measured intensity into a distance corresponding to a radius, and determining the intersection point of the circles with the radius, the position of the centre point x_{c} may be determined.

In case the intensity y as a function of the lateral distance x from the optical axis of the beam is unknown, i.e. the exact shape of an electromagnetic beam is unknown as could be the case when existing remote control devices from different manufacturers or brands are to be used, the invention may still be applied after “calibrating” the position detection. The following algorithm may be used for “calibrating” the position detection. The electromagnetic beam should be directed onto a receiver, for example to the receiver PUL in the upper left corner of the plane surface 10. Then, the electromagnetic beam or the projection of the plane surface 10 should be moved over the surface 10 to another receiver, for example, to the receiver PLR in the lower right corner of the surface 10. During the movement, the signals of all receivers PUL, PUR, PLL, and PLR should be measured and recorded. From these measurements, an estimate of the beam shape may be made. This estimate may then be used to determine the distances of the single receivers from the centre point x_{c} of the electromagnetic beam. Thus, the invention may be used with pointing devices generating nearly any electromagnetic beam shape. This calibration algorithm allows an estimation of the beam shape, and this may be sufficient for the purpose of the invention since most of the beam shapes generated by pointing devices may be approximated by a Gaussian shape so that the above described means of finding the centre position can be used. Thus, a rough estimation of the half width of the shape in a horizontal and a vertical direction of an electromagnetic beam may be sufficient.

Three measurements particularly allow an unambiguous determination of the centre point x_{c} along one dimension. In order to accurately determine the position of the centre point x_{c} in two dimensions, as it is required for the control of a cursor on a display, measurements from receivers at four instead of three different positions should be used. The receivers may be located at the four different edges or corners of a rectangular display. Furthermore, the sensitivity of the receivers should be chosen with regard to the dimensions of the surface on which the electromagnetic beam is projected and the intensity of the electromagnetic radiation. In other words, it should be ensured that a projection of the beam on one end of the surface results in an intensity of the electromagnetic radiation on the other opposite end which is high enough to be measured or detected by a receiver. As a rule of thumb, the intensity of the electromagnetic radiation of the projected beam should be so high that the receiver with the largest distance from the centre point of the beam still receives electromagnetic radiation which may be measured. The range covered by the electromagnetic radiation of the beam projection may be adjusted by the beam width. Thus, it may be helpful to use a beam source which allows adjusting the beam width, either automatically depending on the distance of the beam source from the surface or manually.

FIG. 3 shows a computer display screen 10 displaying a GUI with several windows 12, 14, and 16. The GUI further comprises a cursor 18 in the form of an arrow which may be controlled by a laser pointer 20 used as a pointing device. The laser pointer 20 generates a focused laser light beam 22 (the optical axis of the beam is represented by a simple broken line) which may be directed to the display screen 10 in order to produce a projection of the laser light beam 22 at a centre point x_{c}. The projection of the laser light beam generates laser light radiation not only in or near the centre point x_{c} but also at larger distances from the centre point x_{c} as it is shown with the outer broken lines from the laser pointer 20 to the screen 10. The generated radiation is represented by equi-intensity circles IL0 to IL6 around the centre point x_{c}.

In or near the middle of each of the four edges of the display 10, a photodiode 24, 26, 28, or 30 is located acting as a receiver for the electromagnetic radiation from the laser beam 22. The photodiodes 24, 26, 28, and 30 serve as measuring means for the intensity of the projected laser light beam and, thus, are adapted to convert received laser light radiation into an electric current or voltage representing the intensity of the received laser light radiation. The electric current or voltage measured from each of the photodiodes 24, 26, 28, and 30 is supplied to distance determination means 32 which are adapted to determine the distance of a photodiode 24, 26, 28, or 30 from the centre point x_{c} of the laser light beam projection by means of the intensity measured by the respective photodiode 24, 26, 28, or 30. For example, the distance determination means 32 may implement an algorithm for calculating the distance x with a function y of the intensity over the distance x as shown in FIG. 1. Thus, the function y may be implemented in the distance determination means 32.

The determined distance between each of the photodiodes 24, 26, 28, and 30 and the centre point x_{c} is supplied from the distance determination means 32 to position detection means 34. The position detection means 34 are adapted to calculate the position of the centre point x_{c} on the display screen 10 from the received distances. In order to perform this task, the position detection means 34 implement an algorithm which is adapted to determine a position of a certain point on a plane such as the display 10 from four known distances of the certain point by means of four different and known positions on the plane. The algorithm performs a calculation based on the method for determining the intersection point of four circles with radiuses corresponding to the received distances and middle points on the locations of the photodiodes 24, 26, 28, and 30 as outlined above with regard to FIG. 2. The calculated position of the centre point x_{c} is then supplied to a computer 36 which controls GUI on the display screen 10. The computer 36 comprises a central processing unit CPU executing a computer program with the GUI shown on the display screen 10. Furthermore, the computer 36 comprises a graphics processing unit GPU, which generates graphics output signals for controlling the GUI displayed on the display 10. The position calculated by means 32 is processed by the computer program as the actual position of the cursor 18 and processed by the computer for moving the cursor 18 to the actual calculated cursor position on the display screen 10 or the GUI, respectively.

The invention has the main advantages that it may be implemented at low costs and does not require any optical add-ons to a display screen which degrade the front of screen performance. The invention may be also extended to multi-view display configurations, angle sensitivity, and other features.

The functionality of the invention, particularly the detection of the position of the projection of an electromagnetic beam (spot) on a surface from the measured intensities of the projection may be performed by hard- or software. In case of an implementation in software, a single or multiple standard microprocessors or microcontrollers may be used to process a single or multiple algorithms implementing the invention.

It should be noted that the word “comprise” does not exclude other elements or steps, and that the word “a” or “an” does not exclude a plurality. Furthermore, any reference signs in the claims shall not be construed as limiting the scope of the invention.

1. Device for detecting a position of a projection of an electromagnetic beam (22) on a surface (10), comprising
at least three receivers (24, 26, 28, 30) for receiving electromagnetic radiation from the projection of the electromagnetic beam (22), wherein the receivers are located at different positions at the border of the surface (10),
intensity determination means (32) being adapted to determine the intensities of the electromagnetic radiations received by the receivers, and
position detection means (34) being adapted to determine the centre position x_{c} of the projection of the electromagnetic beam (22) on the surface (10) by processing the determined intensities.

2. Device according to claim 1, wherein four or more receivers (24, 26, 28, 30) are provided.

3. Device according to claim 1, wherein the position detection means (34) are adapted to calculate the centre position x_{c} of the projection of the beam (22) on the surface (10) from the determined intensities based on a predefined beam intensity profile.

4. Device according to claim 3, wherein the position detection means (34) implement a curve fitting algorithm for calculating the centre position x_{c} of the projection of the beam (22) on the surface (10) from the determined intensities based on a predefined beam intensity profile.

5. Device according to claim 3, wherein a lookup table with a plurality of pre-measured values and corresponding positions together with interpolation means is provided, and wherein the position detection means (34) are adapted to load values corresponding to the determined intensities from the lookup table for calculating the centre position x_{c} of the projection of the beam (22) on the surface (10).

6. Device according to claim 3, wherein the predefined beam intensity profile is a circular symmetric profile.

7. Device according to claim 6, wherein the position detection means (34) are adapted to determine an angle of inclination of the beam on the surface by determining a beam intensity profile for the determined intensities and by calculating the angle of inclination in one or two dimensions from the determined beam intensity profile and its deviation from the predefined beam intensity profile.

8. Device according to claim 3, wherein the predefined beam intensity profile is a Gaussian profile.

9. Device according to claim 8, wherein the predefined beam intensity profile is a low intensity Gaussian profile with an additional small-width high intensity spot in the middle of the profile

10. Device according to claim 1, wherein the receivers are sensitive to different wavelengths of received electromagnetic radiation and the intensity determination means (32) are adapted to assign the determined intensities of the electromagnetic radiations with different wavelengths to positions of different electromagnetic beams.

11. Device according to claim 1, wherein the receivers are adapted to receive electromagnetic radiation from the projection of an intensity modulated electromagnetic beam and the intensity determination means (32) are adapted to assign the determined intensities of the electromagnetic radiations with different intensity modulations to positions of different electromagnetic beams.

12. Device according to claim 1, wherein the electromagnetic beam (22) is a beam of visible light and the receivers are sensitive to visible light (24, 26, 28, 30).

13. Device according claim 12, wherein the electromagnetic beam (22) is a laser beam and the receivers are photodiodes (24, 26, 28, 30).

14. Device according to claim 13, wherein the laser beam has such a low intensity as to render it nearly invisible to the naked human eye.

15. Device according to claim 12, wherein the laser beam uses a nonvisible, preferably an infrared wavelength.

16. Device according to claim 1, wherein the electromagnetic beam is a radio wave beam and the receivers are antennas sensitive to radio frequencies.

17. Device according to claim 1, wherein the surface is a display screen and the receivers (24, 26, 28, 30) are located at edges of the display screen (10).

18. Device according to claim 17, wherein the display screen (10) has a rectangular form and each of the receivers is located in a different corner of the display screen.

19. Device according to claim 17, wherein the display screen is a multi-view display screen, and the intensity determination means are adapted to determine the intensities of the electromagnetic radiations received by the receivers from different electromagnetic beams and the position detection means are adapted to determine the centre position x_{c} of the projection of each of the different electromagnetic beams on the multi-view display screen by processing the determined intensities.

20. Display screen unit comprising a display screen and device according to claim 1 for detecting the position of a projection of an electromagnetic beam on the display screen.

21. Display screen unit according to claim 20, further comprising a computer (36) for controlling the position of a cursor (18) displayed on the display screen of the display screen unit based on the detected position of the projection of the electromagnetic beam (22) on the display screen.

22. Method for detecting a position of a projection of an electromagnetic beam (22) on a surface (10), wherein
electromagnetic radiation from the projection of the electromagnetic beam (22) is received by at least three receivers (24, 26, 28, 30) being located at different positions at the border of the surface (10),
the intensities of the electromagnetic radiations received by the receivers are determined by intensity determination means (32), and
the centre position x_{c} of the projection of the electromagnetic beam (22) on the surface (10) is determined by position detection means (34) by processing the determined intensities.
